(19) United States
(12) Patent Application Publication
(10) Pub. No.: US 2025/0324460 A1
(43) Pub. Date: Oct. 16, 2025

(54) ASSOCIATION PERIOD FOR RANDOM ACCESS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed IBRAHIM, San Diego, CA (US)

(21) Appl. No.: 19/095,611

(22) Filed: Mar. 31, 2025

Related U.S. Application Data
(60) Provisional application No. 63/633,382, filed on Apr. 12, 2024.

(51) Int. Cl. H04W 74/0833; H04L 5/14

(52) U.S. Cl. CPC H04W 74/0833; H04L 5/14

(57) ABSTRACT

Methods, systems, and devices for association period for random access are described. The described techniques provide for a user equipment (UE) to receive a random access configuration for subband full duplex (SBFD) operations, where the random access configuration defines an association period for an SBFD-aware UE. During the association period, one or more reference signals may be mapped to a plurality of random access occasions within the association period. The random access configuration may utilize a varying number of physical random access channel configuration periods during an association period for SBFD operations. The UE (which may be an SBFD-aware UE) may then send random access channel preambles to a network entity during one or more random access occasions during the association period.

### CROSS REFERENCE

The present Application for Patent claims the benefit of Provisional Patent Application No. 63/633,382 by ABOTABL et al., entitled “ASSOCIATION PERIOD FOR RANDOM ACCESS,” filed Apr. 12, 2024, assigned to the assignee hereof and hereby expressly incorporated by reference herein.

### FIELD OF TECHNOLOGY

The following relates to wireless communications, including association period for random access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support association period for random access. For example, the described techniques provide for a user equipment (UE) to receive a random access configuration for subband full duplex (SBFD) operations, where the random access configuration defines an association period for an SBFD-aware UE. During the association period, one or more reference signals may be mapped to a plurality of random access occasions within the association period. The random access configuration may utilize a varying number of physical random access channel configuration periods during an association period for SBFD operations. The UE (which may be an SBFD-aware UE) may then send random access channel preambles to a network entity during one or more random access occasions during the association period.

A method for wireless communications by a UE is described. The method may include receiving, from a network entity, an indication of a random access configuration for SBFD operations, the random access configuration indicating an association period for operation in accordance with both of one or more SBFD symbols and one or more non-SBFD symbols, and the association period corresponding to a mapping between one or more reference signals and a plurality of random access occasions within the association period, receiving the one or more reference signals from the network entity, and transmitting, based on the one or more reference signals, a random access message via a random access occasion of the set of multiple random access occasions in accordance with the mapping between the one or more reference signals and the set of multiple random access occasions within the association period.

A UE for wireless communications is described. The UE may include one or more memories storing processor executable code, and one or more processors coupled with the one or more memories. The one or more processors may individually or collectively be operable to execute the code to cause the UE to receive, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period, receive the one or more reference signals from the network entity, and transmit, based on the one or more reference signals, a random access message via a random access occasion of the set of multiple random access occasions in accordance with the mapping between the one or more reference signals and the set of multiple random access occasions within the association period.

Another UE for wireless communications is described. The UE may include means for receiving, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period, means for receiving the one or more reference signals from the network entity, and means for transmitting, based on the one or more reference signals, a random access message via a random access occasion of the set of multiple random access occasions in accordance with the mapping between the one or more reference signals and the set of multiple random access occasions within the association period.

A non-transitory computer-readable medium storing code for wireless communications is described. The code may include instructions executable by one or more processors to receive, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period, receive the one or more reference signals from the network entity, and transmit, based on the one or more reference signals, a random access message via a random access occasion of the set of multiple random access occasions in accordance with the mapping between the one or more reference signals and the set of multiple random access occasions within the association period.

In some examples of the method, UEs, and non-transitory computer-readable medium described herein, transmitting the random access message may include operations, features, means, or instructions for transmitting, during the random access occasion, the random access message via a physical random access channel resource associated with a synchronization signal block index, wherein the random access occasion is selected based at least in part on the association period and on one or more measurements of the one or more reference signals, wherein an association pattern period for operation in accordance with both of one or more SBFD symbols and one or more non-SBFD symbols is different than a second association pattern period for operation in accordance with one or more non-SBFD symbols.

In some examples of the method, UEs, and non-transitory computer-readable medium described herein, transmitting the random access message may include operations, features, means, or instructions for transmitting, during the random access occasion, the random access message via a physical random access channel resource associated with a synchronization signal block index, wherein the random access occasion is selected based at least in part on the association period and on one or more measurements of the one or more reference signals, wherein a time length of the association period is the same as a time length of a second association period for operation in accordance with one or more non-SBFD symbols.

In some examples of the method, UEs, and non-transitory computer-readable medium described herein, an integer number of mappings between the one or more reference signals and the plurality of random access occasions within the association period are different for first operations in accordance with both of one or more SBFD symbols and one or more non-SBFD symbols than second operations in accordance with one or more non-SBFD symbols.

In some examples of the method, UEs, and non-transitory computer-readable medium described herein, transmitting the random access message may include operations, features, means, or instructions for transmitting, during the random access occasion, the random access message via a physical random access channel resource associated with a synchronization signal block index, wherein the random access occasion is selected based at least in part on the association period and on one or more measurements of the one or more reference signals, wherein the association period is determined by the UE and is based at least in part on a minimum integer number of mappings between the one or more reference signals and the plurality of random access occasions.

In some examples of the method, UEs, and non-transitory computer-readable medium described herein, transmitting the random access message may include operations, features, means, or instructions for transmitting, during the random access occasion, the random access message via a physical random access channel resource associated with a synchronization signal block index, wherein the random access occasion is selected based at least in part on the association period and on one or more measurements of the one or more reference signals, wherein the one or more reference signals are mapped to a same set of random access occasions associated with both the one or more SBFD symbols and the one or more non-SBFD symbols as one or more reference signals associated with the one or more non-SBFD symbols, wherein the plurality of random access occasions comprises the same set of random access occasions.

In some examples of the method, UEs, and non-transitory computer-readable medium described herein, a time length of the association period is a same time length as a second association period for operation in accordance with one or more non-SBFD symbols.

In some examples of the method, UEs, and non-transitory computer-readable medium described herein, the association period is determined by the UE and is based on a minimum integer number of mappings between the one or more reference signals and the plurality of random access occasions.

In some examples of the method, UEs, and non-transitory computer-readable medium described herein, the association period is determined by the UE and is based on a minimum integer number of mappings between the one or more reference signals and the plurality of random access occasions ensuring that each of the mappings include a maximum number of random access preambles for transmission.

In some examples of the method, UEs, and non-transitory computer-readable medium described herein, an association pattern period is determined by the UE and comprises one or more association periods within a physical random access channel (PRACH) configuration period and the one or more association periods are exclusively for UEs operating in accordance with both of one or more SBFD symbols and one or more non-SBFD symbols.

In some examples of the method, UEs, and non-transitory computer-readable medium described herein, the one or more association periods is determined by the UE and is based at least in part on an association pattern period for operation in accordance with one or more non-SBFD symbols and a time length of the one or more association periods is different than a total time length of the association pattern period.

In some examples of the method, UEs, and non-transitory computer-readable medium described herein, the one or more association periods may be determined by the UE and may be based on a time length of the PRACH configuration period and a time length of the one or more association periods may be less than a time length of the PRACH configuration period.

### BRIEF DESCRIPTION OF THE DRAWINGS

FIG. 1 shows an example of a wireless communications system that supports association period for random access in accordance with one or more aspects of the present disclosure.

FIG. 2 shows an example of a wireless communications system that supports association period for random access in accordance with one or more aspects of the present disclosure.

FIG. 3 shows an example of a random access configuration that supports association period for random access in accordance with one or more aspects of the present disclosure.

FIG. 4 shows an example of a random access configuration that supports association period for random access in accordance with one or more aspects of the present disclosure.

FIG. 5 shows an example of a random access configuration that supports association period for random access in accordance with one or more aspects of the present disclosure.

FIG. 6 shows an example of a random access configuration that supports association period for random access in accordance with one or more aspects of the present disclosure.

FIG. 7 shows an example of a random access configuration that supports association period for random access in accordance with one or more aspects of the present disclosure.

FIG. 8 shows an example of a process flow that supports association period for random access in accordance with one or more aspects of the present disclosure.

FIGS. 9 and 10 show block diagrams of devices that support association period for random access in accordance with one or more aspects of the present disclosure.

FIG. 11 shows a block diagram of a communications manager that supports association period for random access in accordance with one or more aspects of the present disclosure.

FIG. 12 shows a diagram of a system including a device that supports association period for random access in accordance with one or more aspects of the present disclosure.

FIG. 13 shows a flowchart illustrating methods that support association period for random access in accordance with one or more aspects of the present disclosure.

### DETAILED DESCRIPTION

In some examples of wireless communications, a user equipment (UE) may perform a random access procedure with a network entity. For example, the network entity may configure the UE with one or more random access channel (RACH) occasions (ROs), over which the UE may transmit a random access preamble to request establishment of a wireless connection with the network entity. Additionally, a wireless communications system may implement sub-band full-duplex (SBFD) operations, where a time resource may be associated with both uplink and downlink signaling in respective frequency bandwidths (e.g., sub-bands) associated with the time resource. UEs associated with SBFD operations (e.g., UEs that support SBFD signaling) may be called SBFD-aware UEs.

During a legacy association period, there may be an integer number of physical RACH (PRACH) configuration periods within the association period. In instances where the number of PRACH configuration periods do not align exactly with the association period, then ROs may be dropped. In the case of SBFD-aware UEs, PRACH configuration periods for SBFD operations may be utilized which introduces RACH occasions that are only utilized by SBFD-aware UEs which may have an impact on the PRACH configuration periods within a given association period.

According to techniques described herein, various RACH configurations, including single RACH configurations for all symbol types, and separate RACH configurations for multiple duplex types including for time division duplexing (TDD) (e.g., non-SBFD) and SBFD may be utilized. During the association period, ROs (including those associated with SBFD operations) may be mapped to reference signals such that SBFD-aware UEs may transmit RACH preambles in those ROs. Performing RACH procedures using SBFD may reduce a latency at a UE associated with RACH procedures and may reduce latency associated with access and handover operations in the wireless communications system. As such, supported techniques may include improved network operations and, in some examples, may promote network efficiencies, among other benefits.

Aspects of the disclosure are initially described in the context of wireless communications systems. Aspects of the disclosure are also described in the context of resource diagrams and process flows. Aspects of the disclosure are further illustrated by and described with reference to apparatus diagrams, system diagrams, and flowcharts that relate to association period for random access.

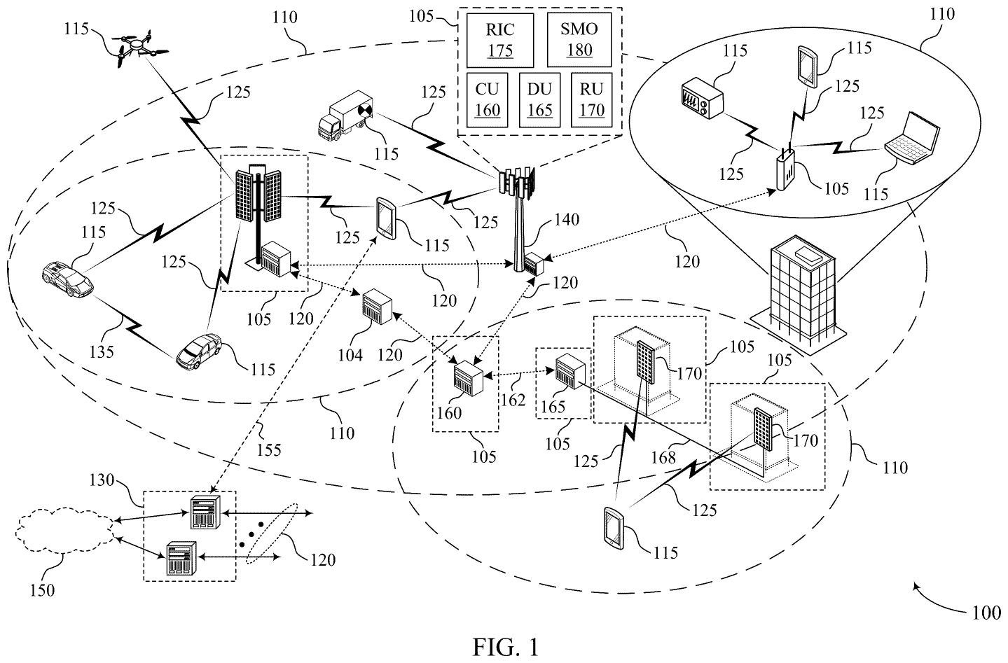

FIG. 1 shows an example of a wireless communications system 100 that supports association period for random access in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

UE 115 may receive a random access configuration for SBFD operations, where the random access configuration defines an association period for an SBFD-aware UE. During the association period, one or more reference signals may be mapped to a plurality of random access occasions within the association period. The random access configuration may utilize a varying number of physical random access channel configuration periods during an association period for SBFD operations. UE 115 (which may be an SBFD-aware UE) may then send random access channel preambles to network entity 105 during one or more random access occasions during the association period.

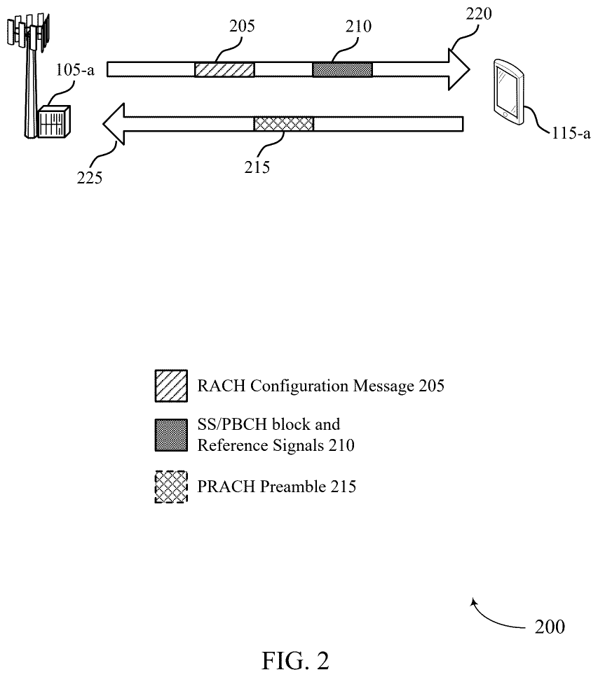

FIG. 2 shows an example of a wireless communications system 200 that supports association period for random access in accordance with one or more aspects of the present disclosure. The wireless communications system 200 may implement or may be implemented by aspects of the wireless communications system 100. For example, the wireless communications system 200 may include UE 115-a, which may be an example of a UE 115 as described herein. The wireless communications system 200 may include network entity 105-a, which may be an example of a network entity 105 as described herein.

In some examples of wireless communications system 200, UE 115-a and network entity 105-a may operate in accordance with one or more random access procedures. For instance, UE 115-a may use a random access procedure to initiate communication with network entity 105-a when UE 115-a has data to send, when UE 115-a desires to establish a connection with network entity 105-a, or both. UE 115-a and the network entity 105-a may communicate via a downlink channel 220 and the uplink channel 225. UE 115-a may perform a random access procedure with network entity 105-a in accordance with a RACH configuration message 205 received via downlink channel 220.

In the random access procedure, the UE 115-a may be provided a number of synchronization signal (SS) or physical broadcast channel (PBCH) indexes in addition to one or more reference signals 210. SS/PBCH block indexes and reference signals 210 may be mapped to valid ROs. A set of ROs may refer to respective time intervals within the communication protocol where UE 115-a may initiate the RACH procedure to access network entity 105-a. In some examples, The RACH configuration indicated in RACH configuration message 205 may enable UE 115-a to determine the valid ROs and to determine how synchronization signal blocks (SSBs) are mapped to ROs. For instance, RACH configuration message 205 may be an example of a PRACH configuration (e.g., as part of RRC configuration), which may configure one or more tables including respective PRACH configurations. As part of the random access procedure, UE 115-a may transmit to network entity 105-a one or more PRACH preambles 215 via uplink channel 225 utilizing one or more corresponding ROs, where the PRACH preamble 215 serves as a request for access to network entity 105-a.

In cases of both four-step RACH (e.g., type 1 RACH) and two-step RACH (e.g., type 2 RACH), a configured PRACH slot may span different types of symbols. For example, a PRACH slot may span both SBFD symbols and non-SBFD symbols. As described herein, an SBFD symbol may include both uplink resources and downlink resources which may allow for concurrent transmission and reception of data at UE 115-a. Additionally, or alternatively, a non-SBFD symbol may include either uplink resources or flexible resources that may allow for UE 115-a to transmit data. In an example, a PRACH slot (e.g., that includes one or more ROs) may span a single slot that includes both SBFD resources and non-SBFD resources. The RACH configuration message 205 may indicate which slots are SBFD slots.

An association period for mapping SS/PBCH block indexes to ROs is the smallest value in the set determined by the PRACH configuration period according to the following Table 1 such that an integer number of SS/PBCH block indexes are mapped at least once to the ROs within the association period.

TABLE 1

| PRACH configuration period | Association period |
|---|---|
| (msec) | (number of PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

If after an integer number of SS/PBCH block indexes to RO mapping cycles within the association period such that there is a set of ROs which is not mapped to SS/PBCH block indexes, no SS/PBCH block indexes are mapped to the set of ROs. ROs not associated with SS/PBCH block indexes after an integer number of association periods, if any, may not be used for RACH transmissions. An association pattern period may include one or more association periods.

Network entity 105-a and UE 115-a may increase the efficiency of RACH preamble transmission by operating in accordance with the techniques described herein. Various RACH configurations, including single RACH configurations for all symbol types, and separate RACH configurations for multiple duplex types including for TDD and SBFD may be utilized. During the association period, ROs (including those associated with SBFD operations) may be mapped to reference signals such that SBFD-aware UEs (e.g., UEs 115 operating in accordance with SBFD symbols and non-SBFD symbols) may transmit RACH preambles in those ROs.

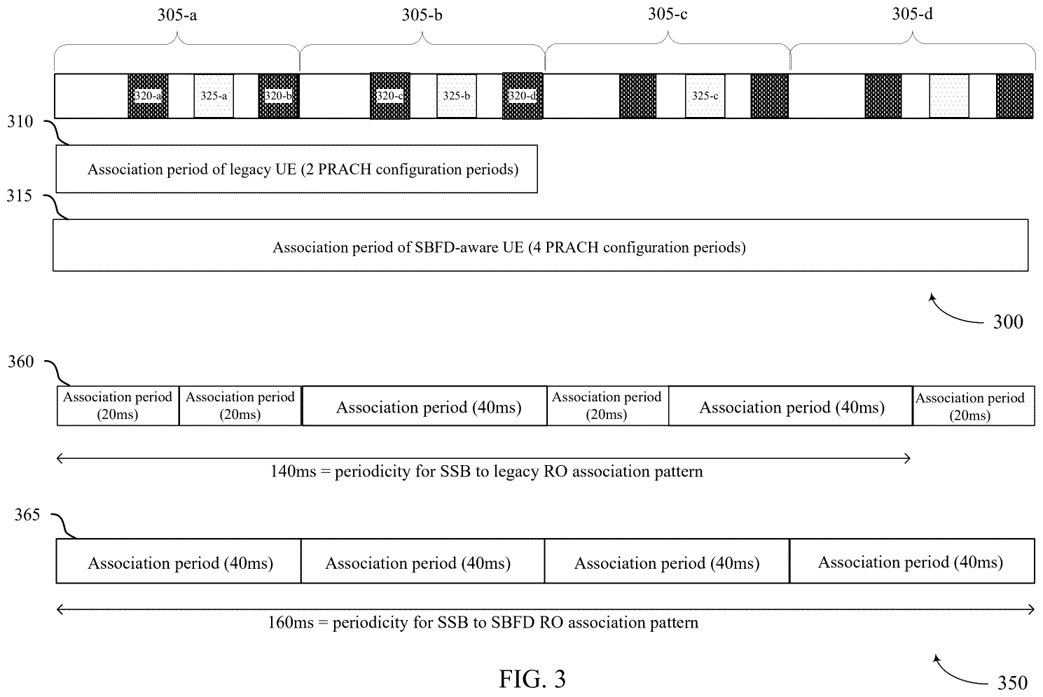

FIG. 3 shows examples of random access configurations 300 and 350 that supports association period for random access in accordance with one or more aspects of the present disclosure. The random access configurations 300 and 350 may illustrate various instances of a mapping between one or more reference signals and a plurality of random access occasions within an association period.

Random access configuration 300 illustrates PRACH configuration periods 305, an association period 310 of a legacy UE (e.g., a non-SBFD aware UE, a UE operating in accordance with non-SBFD symbols), and an association period 315 of an SBFD aware UE. Association periods 310 and 315 may be integer multiples of a PRACH configuration period. PRACH configuration periods may include ROs 320 that are available for all UEs (e.g., ROs associated with non-SBFD symbols, non-SBFD-ROs, legacy-ROs, RO 320-a, RO 320-b, RO 320-c, RO 320-d) and ROs 325 that are available for SBFD aware UEs (e.g., ROs associated with SBFD symbols, SBFD-ROs).

Random access configuration 300 may be an example of where SSB to RO mappings are separate for association periods associated with legacy UEs and SBFD aware UEs. Random access configuration 300 illustrates association period 310 and association period 315, which are maintained separately. In an example where three beams are being mapped for a legacy UE, ROs 320-a, 320-b, and 320-c will be mapped to reference signals associated with three different beams. In turn, association period 310 will be two PRACH configuration periods (e.g., PRACH configuration periods 305-a and 305-b) because it is the smallest integer number of PRACH configuration periods that will map all three ROs 320.

In an example where three beams are being mapped for an SBFD aware UE, ROs 325-a, 325-b, and 325-c will be mapped to reference signals associated with three different beams. In turn, an SBFD aware UE may determine that association period 315 will be four PRACH configuration periods (e.g., PRACH configuration periods 305-a, 305-b, 305-c, and 305-d). In this case, four PRACH configuration periods is the smallest integer number of PRACH configuration periods that will map all three ROs 325 as four is the next smallest integer number after two as indicated in Table 1. In this example, association period 315 is longer than association period 310, however, where separate association periods for legacy UEs and SBFD aware UEs are maintained, association periods associated with SBFD aware UEs may be smaller than association periods associated with legacy UEs. Here, non-SBFD aware UEs may utilize association period 310 and SBFD aware UEs may utilize association period 315.

Random access configuration 350 may be another example of SSB to RO mappings which are separate for association periods associated with legacy UEs and SBFD aware UEs. Random access configuration 350 may illustrate how changes in association periods may result in changes in association period patterns. For example, association period pattern 360 may be associated with legacy UEs and may include various association periods, including those having durations of 20 ms and 40 ms. Association period pattern 360 may have a periodicity of 140 ms. Association period pattern 365 may be associated with SBFD aware UEs and may include association periods having durations of 40 ms. Association period pattern 365 may have a periodicity of 160 ms.

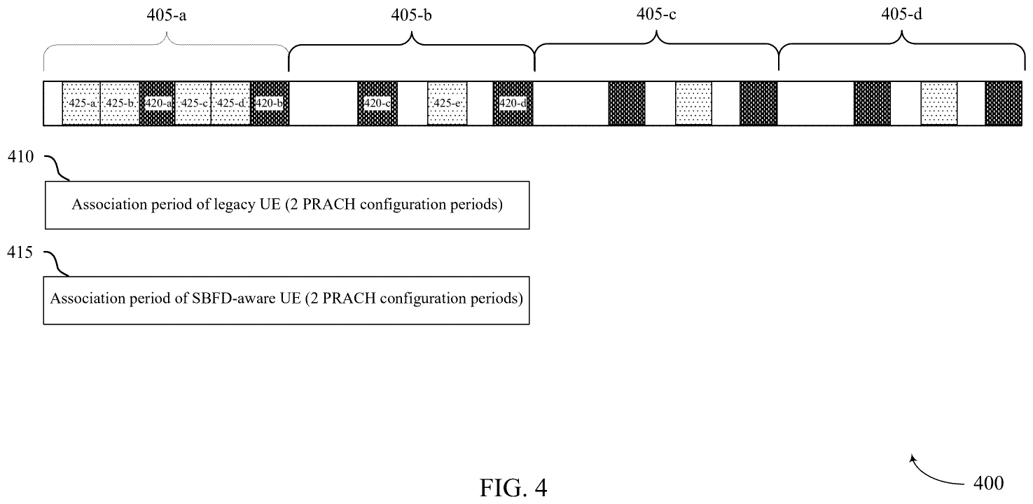

FIG. 4 shows an example of a random access configuration 400 that supports association period for random access in accordance with one or more aspects of the present disclosure. The random access configuration 400 may illustrate various instances of a mapping between one or more reference signals and a plurality of random access occasions within an association period.

Random access configuration 400 illustrates PRACH configuration periods 405 (e.g., PRACH configuration periods 405-a, 405-b, 405-c, and 405-d), an association period 410 of a legacy (non-SBFD aware) UE, and an association period 415 of an SBFD aware UE. Association periods 410 and 415 may be integer multiples of a PRACH configuration period. PRACH configuration periods may include ROs 420 that are available for all UEs (e.g., ROs associated with non-SBFD symbols, non-SBFD-ROs, legacy-ROs, RO 420-a, RO 420-b, RO 420-c, RO 420-d) and ROs 425 that are available for SBFD aware UEs (e.g., ROs associated with SBFD symbols, SBFD-ROs).

Random access configuration 400 may be an example of where SSB to RO mappings have non-separate association periods associated with legacy UEs and SBFD aware UEs. Random access configuration 400 illustrates association period 410 which is the same as association period 415. In this example, ROs 425 (e.g., ROs 425-a, 425-b, 425-c, 425-d, 425-c) that are available for SBFD aware UEs will be ignored and each of association periods 410 and 415 will be defined based on a legacy UE association period. In an example where three beams are being mapped for a legacy UE, ROs 420-a, 420-b, and 420-c will be mapped to reference signals associated with three different beams. In turn, association period 410 will be two PRACH configuration periods (e.g., PRACH configuration periods 405-a and 405-b) because it is the smallest integer number of PRACH configuration periods that will map all three ROs 420. Because association period 415 is the same as association period 410, an SBFD aware UE may determine that association period 415 will also be two PRACH configuration periods (e.g., PRACH configuration periods 405-a and 405-b). Here, both non-SBFD aware UEs and SBFD aware UEs may utilize an association period of two PRACH configuration periods.

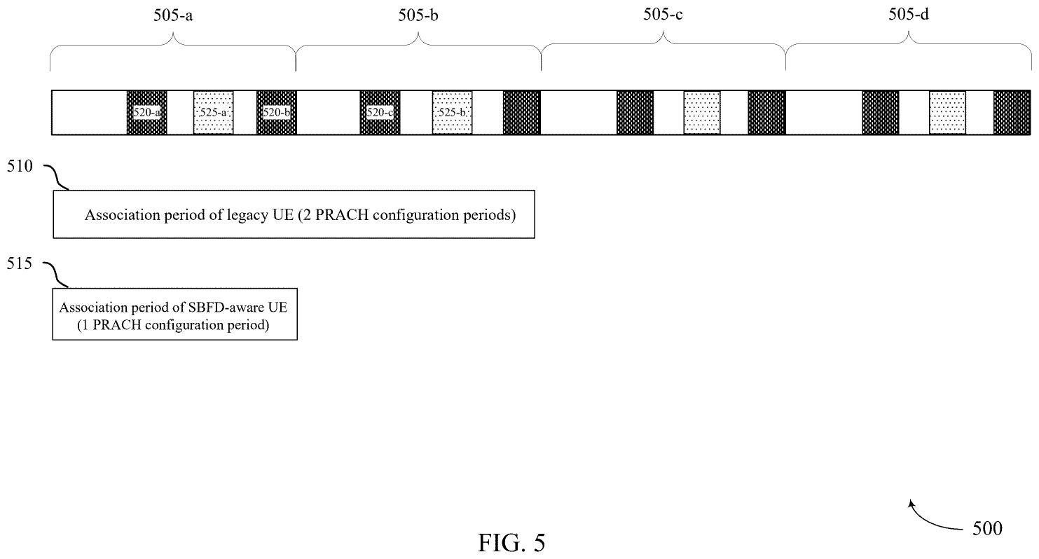

FIG. 5 shows an example of a random access configuration 500 that supports association period for random access in accordance with one or more aspects of the present disclosure. The random access configuration 500 may illustrate various instances of a mapping between one or more reference signals and a plurality of random access occasions within an association period.

Random access configuration 500 illustrates PRACH configuration periods 505 (e.g., PRACH configuration periods 505-a, 505-b, 505-c, and 505-d), an association period 510 of a legacy (non-SBFD aware) UE, and an association period 515 of an SBFD aware UE. Association periods 510 and 515 may be integer multiples of a PRACH configuration period. PRACH configuration periods may include ROs 520 that are available for all UEs (e.g., ROs associated with non-SBFD symbols, non-SBFD-ROs, legacy-ROs, RO 520-a, RO 520-b, RO 520-c) and ROs 525 that are available for SBFD aware UEs (e.g., ROs associated with SBFD symbols, SBFD-ROs, RO 525-a, RO 525-b).

Random access configuration 500 may be an example of a single RACH configuration for a SBFD aware UE. Random access configuration 500 illustrates association period 515 which is for SBFD aware UEs (association period 510 is shown for comparison purposes). In this example, an SBFD aware UE may utilize both ROs 520 and 525. As a result, where three beams are being mapped to ROs, an SBFD aware UE may utilize ROs 520-a, 525-a, and 520-b to map to reference signals associated with the three different beams. In turn, an SBFD aware UE may determine that association period 515 will be one PRACH configuration period (e.g., PRACH configuration periods 505-a) because it is the smallest integer number of PRACH configuration periods that will map all three ROs.

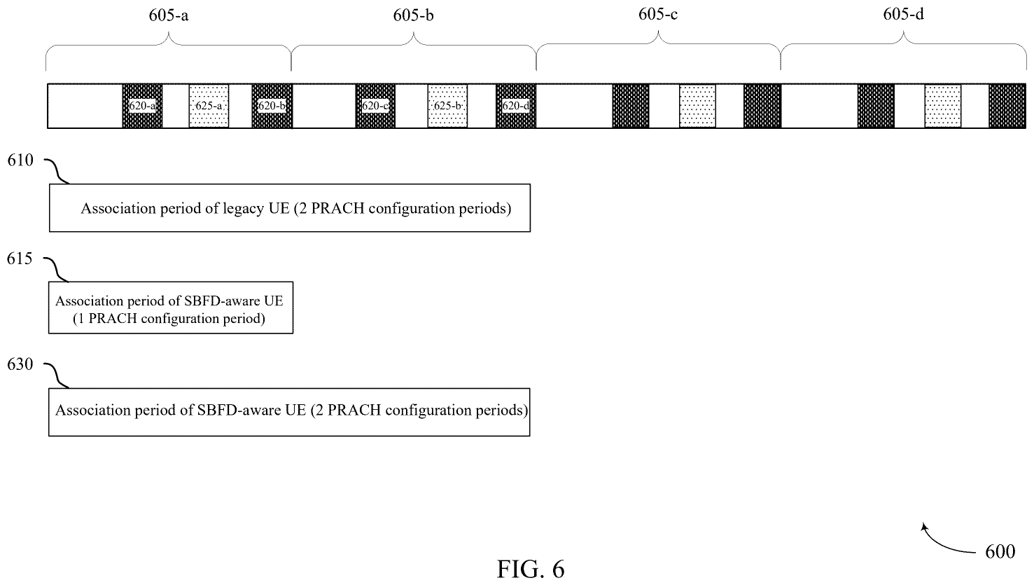

FIG. 6 shows an example of a random access configuration 600 that supports association period for random access in accordance with one or more aspects of the present disclosure. The random access configuration 600 may illustrate various instances of a mapping between one or more reference signals and a plurality of random access occasions within an association period.

Random access configuration 600 illustrates PRACH configuration periods 605 (e.g., PRACH configuration periods 605-a, 605-b, 605-c, and 605-d), an association period 610 of a legacy (non-SBFD aware) UE, and association periods 615 and 630 of an SBFD aware UE. Association periods 610, 615, and 630 may be integer multiples of a PRACH configuration period. PRACH configuration periods may include ROs 620 that are available for all UEs (e.g., ROs associated with non-SBFD symbols, non-SBFD-ROs, legacy-ROs) and ROs 625 that are available for SBFD aware UEs (e.g., ROs associated with SBFD symbols, SBFD-ROs, RO 625-a, RO 625-b).

Random access configuration 600 may be an example of where SSB to RO mappings are jointly mapped for association periods associated with legacy UEs and SBFD aware UEs. In an example where three beams are being mapped for a legacy UE, ROs 620-a, 620-b, and 620-c will be mapped to reference signals associated with three different beams. In turn, association period 610 will be two PRACH configuration periods (e.g., PRACH configuration periods 605-a and 605-b) because it is the smallest integer number of PRACH configuration periods that will map all three ROs 620.

In an example where SSB to RO mappings are jointly mapped for association periods, ROs may be mapped such that ROs 620 that are available for all UEs may be mapped jointly with SBFD aware UEs. For example, ROs 620-b, 620-c, and 620-d may be jointly mapped such that respective SSBs for both non-SBFD aware and SBFD aware UEs are mapped to a single RO 620. Under this scenario, the RACH preambles available for the RO are split for each respective SSB associated with the non-SBFD aware and SBFD aware UEs. In an example where an RO 620 is jointly mapped, 32 RACH preambles may be equally apportioned to each respective SSB associated with the non-SBFD aware and SBFD aware UEs as opposed to 64 RACH preambles that may be apportioned to a single SSB.

In a first example of where SSB to RO mappings are jointly mapped for association periods, an association period 610 for legacy UEs may be determined to be two PRACH configuration periods as explained above. A corresponding association period of a SBFD aware UE may be the same integer number of RACH configuration periods as association period 610.

In a second example of where SSB to RO mappings are jointly mapped for association periods, an association period 610 for legacy UEs may be determined to be two PRACH configuration periods as explained above. However, a corresponding association period of a SBFD aware UE may be determined such that all associated SSBs are mapped at least once regardless of the number of RACH preambles available. In an example where three beams are being mapped for an SBFD aware UE, an SBFD aware UE may determine that association period 615 may be one PRACH configuration period as the three SSBs may be mapped to ROs 620-a, 625-a, and 620-b even though RO 620-b has split its RACH preambles between an SSB associated with a non-SBFD aware UE and an SSB associated with a SBFD aware UE. As such, RO 620-b may be apportioned such that 32 RACH preambles are available to the SBFD aware UE in RO 620-b.

In a third example of where SSB to RO mappings are jointly mapped for association periods, an association period 610 for legacy UEs may be determined to be two PRACH configuration periods as explained above. However, a corresponding association period of a SBFD aware UE may be determined such that all associated SSBs are mapped at least once with the complete number of preambles. In an example where three beams are being mapped for an SBFD aware UE, an SBFD aware UE may determine that association period 630 may be two PRACH configuration periods. In contrast to the second example above, association period 630 is not one PRACH configuration period since RO 620-b has only a portion of RACH preambles available for the SBFD aware UE and not a complete amount of RACH preambles. Although ROs 620-c and 620-d are also jointly mapped in a similar manner to RO 620-b, the additional ROs 620-c and 620-d may be mapped to SSBs in association period 630 such that a complete amount of RACH preambles are available for an SBFD aware UE to utilize in the mapping of three beams.

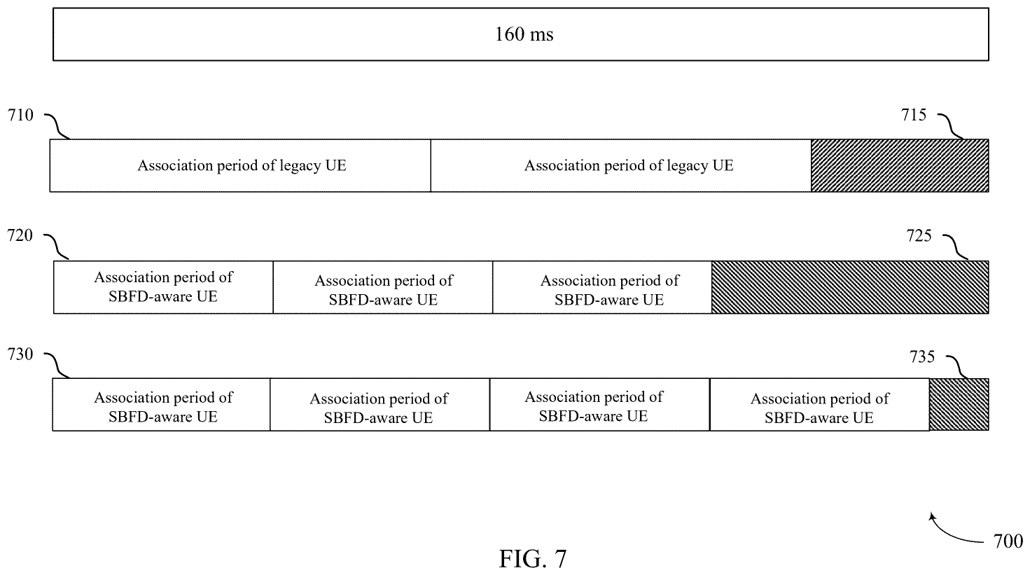

FIG. 7 shows an example of a random access configuration 700 that supports association period for random access in accordance with one or more aspects of the present disclosure. The random access configuration 700 may illustrate various instances of a mapping between one or more reference signals and a plurality of random access occasions within an association period.

Random access configuration 700 may include association pattern periods 710, 720, and 730. In an example over a 160 ms period, association pattern period 710 of a legacy UE may span a portion of the 160 ms period, however, ROs associated with period 715 may be left unmapped. In a first example, association pattern period 720 for an SBFD aware UE is determined so that the association periods of association pattern period 720 for an SBFD aware UE are repeated such that an association period does not overlap with period 715. In the first example, association pattern period 720 may include SSB to RO mappings but period 725 is left unmapped.

In a second example, association pattern period 730 for an SBFD aware UE is determined so that association periods of association pattern period 730 for an SBFD aware UE are repeated until the maximum period is reached (e.g., a PRACH configuration period of 160 ms). In the second example, association pattern period 730 may include SSB to RO mappings but period 735 is left unmapped.

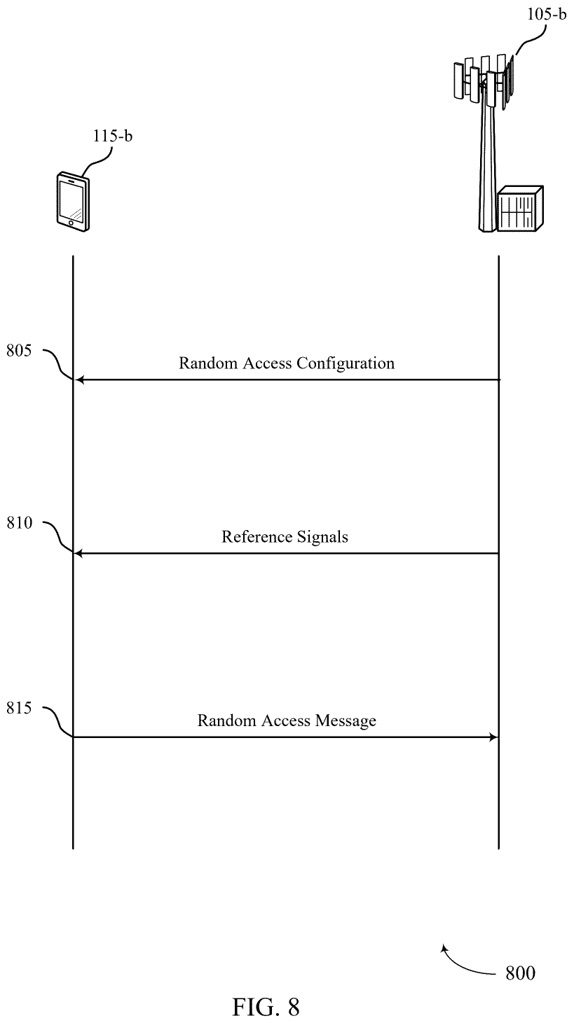

FIG. 8 shows an example of a process flow 800 that supports association period for random access in accordance with one or more aspects of the present disclosure. The process flow 800 may illustrate an example of a RACH procedure.

At 805, network entity 105-b may transmit, and UE 115-b may receive, an indication of a random access configuration for SBFD operations. The random access configuration may indicate an association period for an SBFD-aware UE (e.g., a UE operating in accordance with both of one or more SBFD symbols and one or more non-SBFD symbols). The random access configuration may also indicate a mapping between one or more reference signals and a plurality of random access occasions within the association period.

At 810, network entity 105-b may transmit, and UE 115-b may receive, one or more reference signals from the network entity.

At 815, UE 115-b may transmit, and network entity 105-b may receive, an random access message via a random access occasion in accordance with the mapping between the one or more reference signals and the plurality of random access occasions within the association period. The random access message may be transmitted by UE 115-b via a physical random access channel resource associated with a synchronization signal block index.

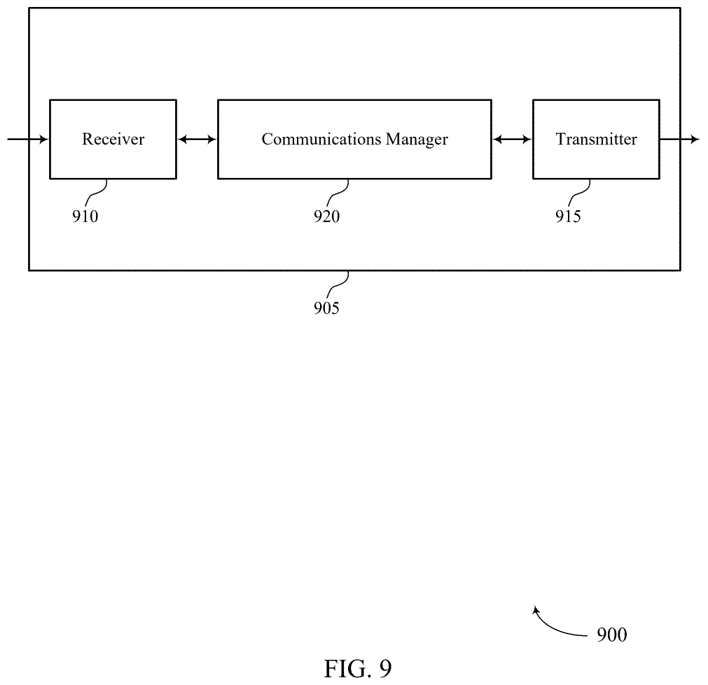

FIG. 9 shows a block diagram 900 of a device 905 that supports association period for random access in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to association period for random access). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to association period for random access). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of association period for random access as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communications in accordance with examples as disclosed herein. For example, the communications manager 920 is capable of, configured to, or operable to support a means for receiving, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period. The communications manager 920 is capable of, configured to, or operable to support a means for receiving the one or more reference signals from the network entity. The communications manager 920 is capable of, configured to, or operable to support a means for transmitting, based on the one or more reference signals, a random access message via a random access occasion of the set of multiple random access occasions in accordance with the mapping between the one or more reference signals and the set of multiple random access occasions within the association period.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for performing RACH procedures using SBFD may reduce a latency at a UE associated with RACH procedures, and may reduce latency associated with access and handover operations in the wireless communications system. As such, supported techniques may include improved network operations and, in some examples, may promote network efficiencies, among other benefits

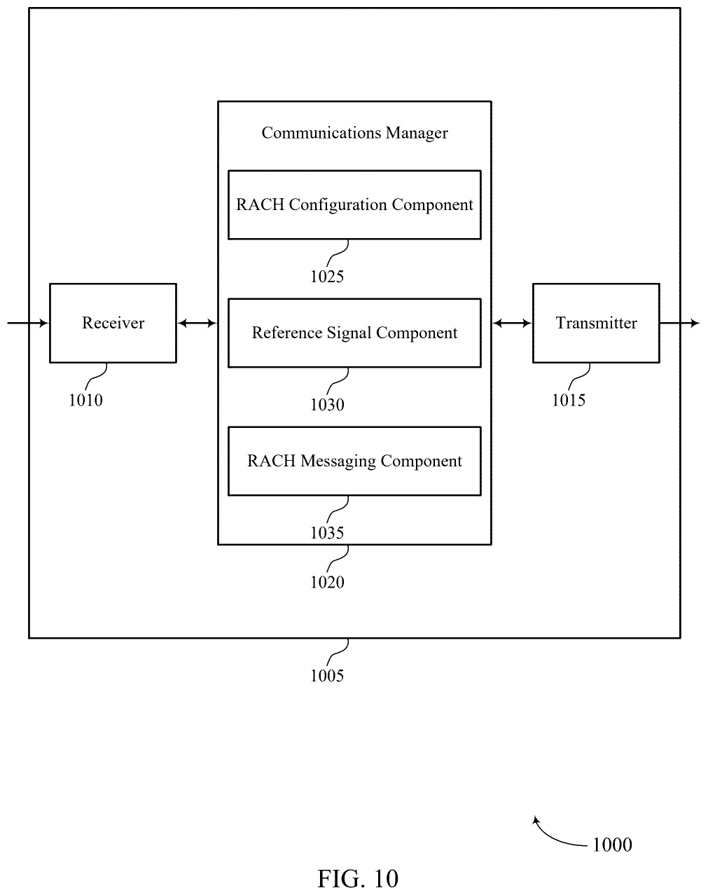

FIG. 10 shows a block diagram 1000 of a device 1005 that supports association period for random access in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to association period for random access). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to association period for random access). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of association period for random access as described herein. For example, the communications manager 1020 may include, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The RACH configuration component 1025 is capable of, configured to, or operable to support a means for receiving, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period. The reference signal component 1030 is capable of, configured to, or operable to support a means for receiving the one or more reference signals from the network entity. The RACH messaging component 1035 is capable of, configured to, or operable to support a means for transmitting, based on the one or more reference signals, a random access message via a random access occasion of the set of multiple random access occasions in accordance with the mapping between the one or more reference signals and the set of multiple random access occasions within the association period.

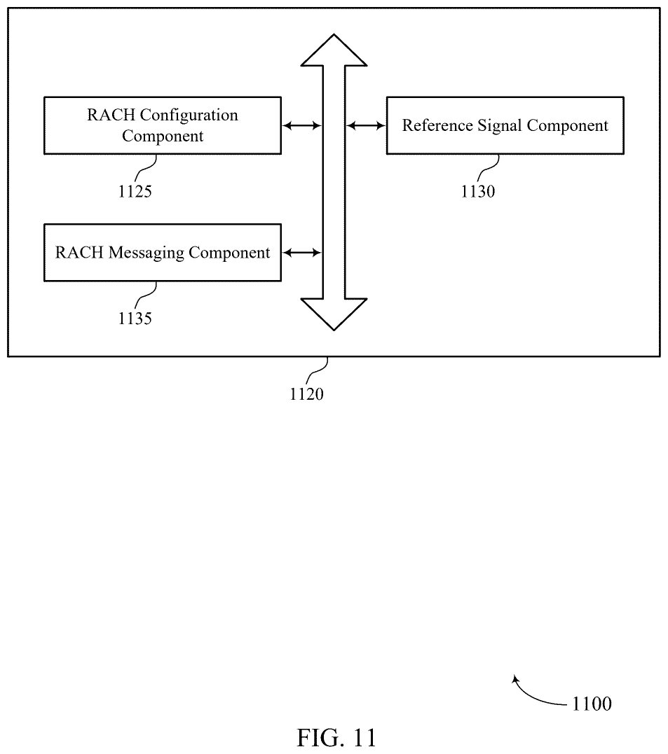

FIG. 11 shows a block diagram 1100 of a communications manager 1120 that supports association period for random access in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of association period for random access as described herein. For example, the communications manager 1120 may include, or any combination thereof. Each of these components, or components or subcomponents thereof (e.g., one or more processors, one or more memories), may communicate, directly or indirectly, with one another (e.g., via one or more buses).

Additionally, or alternatively, the communications manager 1120 may support wireless communications in accordance with examples as disclosed herein. The RACH configuration component 1125 is capable of, configured to, or operable to support a means for receiving, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period. In some examples, the reference signal component 1130 is capable of, configured to, or operable to support a means for receiving the one or more reference signals from the network entity. In some examples, the reference signal component 1130 is capable of, configured to, or operable to support a means for transmitting, based on the one or more reference signals, a random access message via a random access occasion of the set of multiple random access occasions in accordance with the mapping between the one or more reference signals and the set of multiple random access occasions within the association period.

In some examples, to support transmitting the random access message, the RACH messaging component 1135 is capable of, configured to, or operable to support a means for transmitting, during the random access occasion, the random access message via a physical random access channel resource associated with a synchronization signal block index, where the random access occasion is selected based at least in part on the association period and on one or more measurements of the one or more reference signals, where an association pattern period for operation in accordance with both of the one or more SBFD symbols and the one or more non-SBFD symbols is different than a second association pattern period for operation in accordance with one or more non-SBFD symbols.

In some examples, to support transmitting the random access message, the RACH messaging component 1135 is capable of, configured to, or operable to support a means for transmitting, during the random access occasion, the random access message via a physical random access channel resource associated with a synchronization signal block index, where the random access occasion is selected based at least in part on the association period and on one or more measurements of the one or more reference signals, where a time length of the association period is the same as a time length of a second association period for operation in accordance with the one or more non-SBFD symbols.

In some examples, an integer number of mappings between the one or more reference signals and the plurality of random access occasions within the association period are different for the operation in accordance with both of the one or more SBFD symbols and the one or more non-SBFD symbols than operation in accordance with the one or more non-SBFD symbols (e.g., and not in accordance with the one or more SBFD symbols).

In some examples, to support transmitting the random access message, the RACH messaging component 1135 is capable of, configured to, or operable to support a means for transmitting, during the random access occasion, the random access message via a physical random access channel resource associated with a synchronization signal block index, where the random access occasion is selected based at least in part on the association period and on one or more measurements of the one or more reference signals, where the association period is determined by the UE and is based at least in part on a minimum integer number of mappings between the one or more reference signals and the plurality of random access occasions.

In some examples, to support transmitting the random access message, the RACH messaging component 1135 is capable of, configured to, or operable to support a means for transmitting, during the random access occasion, the random access message via a physical random access channel resource associated with a synchronization signal block index, where the random access occasion is selected based at least in part on the association period and on one or more measurements of the one or more reference signals, where the one or more reference signals are mapped to a same set of random access occasions associated with both the one or more SBFD symbols and the one or more non-SBFD symbols as one or more reference signals associated with the one or more non-SBFD symbols, wherein the plurality of random access occasions comprises the same set of random access occasions.

In some examples, a time length of the association period is a same time length as a second association period for operation in accordance with the one or more non-SBFD symbols (e.g., and not in accordance with the one or more SBFD symbols).

In some examples, the association period is determined by the UE and is based on a minimum integer number of mappings between the one or more reference signals and the plurality of random access occasions.

In some examples, the association period is determined by the UE and is based on a minimum integer number of mappings between the one or more reference signals and the plurality of random access occasions ensuring that each of the mappings include a maximum number of random access preambles for transmission.

In some examples, an association pattern period is determined by the UE and includes one or more association periods within a PRACH configuration period. In some examples, the one or more association periods are exclusively for UEs operating in accordance with both of one or more SBFD symbols and one or more non-SBFD symbols.

In some examples, the one or more association periods is determined by the UE and is based at least in part on a second association pattern period for operation in accordance with one or more non-SBFD symbols (e.g., and not in accordance with the one or more SBFD symbols). In some examples, a time length of the one or more association periods is different than a total time length of the second association pattern period.

In some examples, the one or more association periods is determined by the UE and is based on a time length of the PRACH configuration period. In some examples, a time length of the one or more association periods is less than a time length of the PRACH configuration period.

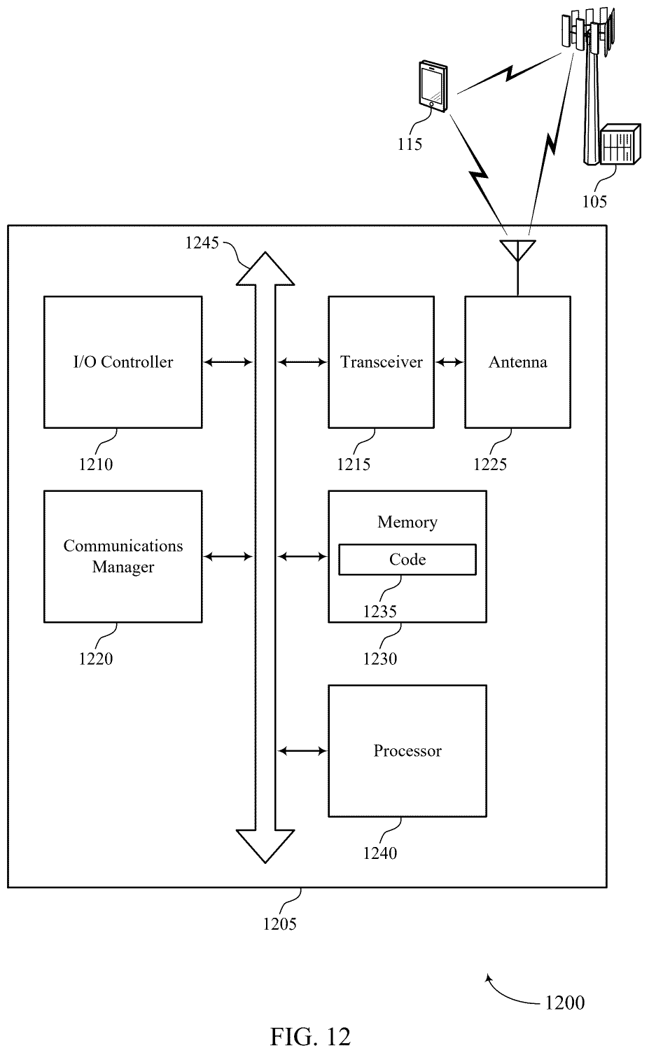

FIG. 12 shows a diagram of a system 1200 including a device 1205 that supports association period for random access in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting association period for random access). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

Additionally, or alternatively, the communications manager 1220 may support wireless communications in accordance with examples as disclosed herein. For example, the communications manager 1220 is capable of, configured to, or operable to support a means for receiving, from a network entity, from a network entity, an indication of a random access configuration for SBFD operations, the random access configuration indicating an association period for operation in accordance with both of the one or more SBFD symbols and the one or more non-SBFD symbols, and the random access configuration corresponding to a mapping between one or more reference signals and a plurality of random access occasions within the association period. The communications manager 1220 is capable of, configured to, or operable to support a means for receiving the one or more reference signals from the network entity. The communications manager 1220 is capable of, configured to, or operable to support a means for transmitting, based on the one or more reference signals, a random access message via a random access occasion of the set of multiple random access occasions in accordance with the mapping between the one or more reference signals and the set of multiple random access occasions within the association period.

By including or configuring the communications manager 1220 in accordance with examples as described herein, the device 1205 may support techniques for performing RACH procedures using SBFD may reduce a latency at a UE associated with RACH procedures, and may reduce latency associated with access and handover operations in the wireless communications system. As such, supported techniques may include improved network operations and, in some examples, may promote network efficiencies, among other benefits.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of association period for random access as described herein, or the at least one processor 1240 and the at least one memory 1230 may be otherwise configured to, individually or collectively, perform or support such operations.

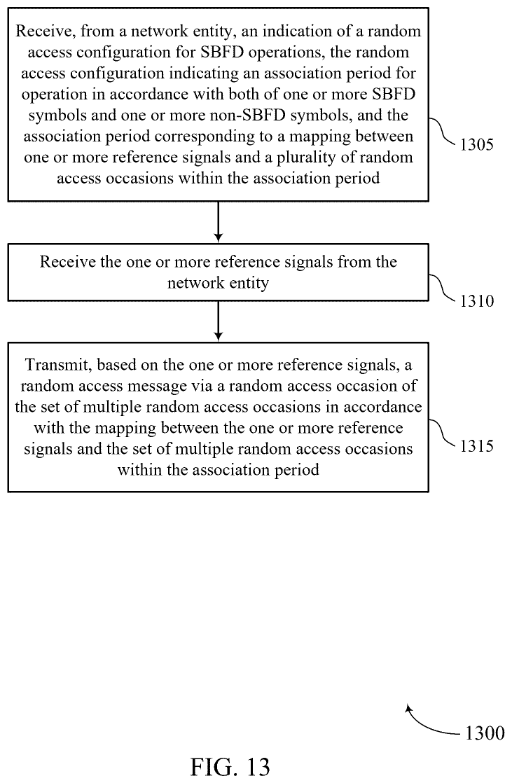

FIG. 13 shows a flowchart illustrating a method 1300 that supports association period for random access in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, an indication of a random access configuration for SBFD operations, the random access configuration indicating an association period for operation in accordance with both of one or more SBFD symbols and one or more non-SBFD symbols, and the association period corresponding to a mapping between one or more reference signals and a plurality of random access occasions within the association period. The operations of 1305 may be performed in accordance with examples as disclosed herein. In some examples, aspects of the operations of 1305 may be performed by a RACH configuration component 1125 as described with reference to FIG. 11.

At 1310, the method may include receiving the one or more reference signals from the network entity. The operations of 1310 may be performed in accordance with examples as disclosed herein. In some examples, aspects of the operations of 1310 may be performed by a reference signal component 1130 as described with reference to FIG. 11.

At 1315, the method may include transmitting, based on the one or more reference signals, a random access message via a random access occasion of the set of multiple random access occasions in accordance with the mapping between the one or more reference signals and the set of multiple random access occasions within the association period. The operations of 1315 may be performed in accordance with examples as disclosed herein. In some examples, aspects of the operations of 1315 may be performed by a RACH messaging component 1135 as described with reference to FIG. 11.

The following provides an overview of aspects of the present disclosure:

Aspect 1: A method for wireless communications at a UE, comprising: receiving, from a network entity, an indication of a random access configuration for SBFD operations, the random access configuration indicating an association period for operation in accordance with both of one or more SBFD symbols and one or more non-SBFD symbols, and the random access configuration corresponding to a mapping between one or more reference signals and a plurality of random access occasions within the association period; receiving the one or more reference signals from the network entity; and transmitting, based at least in part on the one or more reference signals, a random access message via a random access occasion of the plurality of random access occasions in accordance with the mapping between the one or more reference signals and the plurality of random access occasions within the association period.

Aspect 2: The method of aspect 1, wherein transmitting the random access message comprises: transmitting, during the random access occasion, the random access message via a physical random access channel resource associated with a synchronization signal block index, wherein the random access occasion is selected based at least in part on the association period and on one or more measurements of the one or more reference signals, wherein an association pattern period for operation in accordance with both of the one or more SBFD symbols and the one or more non-SBFD symbols is different than a second association pattern period for operation in accordance with the one or more non-SBFD symbols.

Aspect 3: The method of any of aspects 1 through 2, wherein transmitting the random access message comprises: transmitting, during the random access occasion, the random access message via a physical random access channel resource associated with a synchronization signal block index, wherein the random access occasion is selected based at least in part on the association period and on one or more measurements of the one or more reference signals, wherein a time length of the association period is the same as a time length of a second association period for operation in accordance with the one or more non-SBFD symbols.

Aspect 4: The method of aspect 3, wherein an integer number of mappings between the one or more reference signals and the plurality of random access occasions within the association period are different for the operation in accordance with both of the one or more SBFD symbols and the one or more non-SBFD symbols than operation in accordance with the one or more non-SBFD symbols.

Aspect 5: The method of any of aspects 1 through 4, wherein transmitting the random access message comprises: transmitting, during the random access occasion, the random access message via a physical random access channel resource associated with a synchronization signal block index, wherein the random access occasion is selected based at least in part on the association period and on one or more measurements of the one or more reference signals, wherein the association period is determined by the UE and is based at least in part on a minimum integer number of mappings between the one or more reference signals and the plurality of random access occasions.

Aspect 6: The method of any of aspects 1 through 5, wherein transmitting the random access message comprises: transmitting, during the random access occasion, the random access message via a physical random access channel resource associated with a synchronization signal block index, wherein the random access occasion is selected based at least in part on the association period and on one or more measurements of the one or more reference signals, wherein the one or more reference signals are mapped to a same set of random access occasions associated with both the one or more SBFD symbols and the one or more non-SBFD symbols as one or more reference signals associated with the one or more non-SBFD symbols, wherein the plurality of random access occasions comprises the same set of random access occasions.

Aspect 7: The method of aspect 6, wherein a time length of the association period is a same time length as a second association period for operation in accordance with the one or more non-SBFD symbols.

Aspect 8: The method of any of aspects 6 through 7, wherein the association period is determined by the UE and is based on a minimum integer number of mappings between the one or more reference signals and the plurality of random access occasions.

Aspect 9: The method of any of aspects 6 through 8, wherein the association period is determined by the UE and is based on a minimum integer number of mappings between the one or more reference signals and the plurality of random access occasions ensuring that each of the mappings include a maximum number of random access preambles for transmission.

Aspect 10: The method of any of aspects 1 through 9, wherein an association pattern period is determined by the UE and comprises one or more association periods within a PRACH configuration period, and the one or more association periods are exclusively for UEs operating in accordance with both of the one or more SBFD symbols and the one or more non-SBFD symbols.

Aspect 11: The method of aspect 10, wherein the one or more association periods is determined by the UE and is based at least in part on a second association pattern period for operation in accordance with the one or more non-SBFD symbols, and a time length of the one or more association periods is different than a total time length of the second association pattern period.

Aspect 12: The method of any of aspects 10 through 11, wherein the one or more association periods are determined by the UE and are based at least in part on a time length of the PRACH configuration period, and a time length of the one or more association periods is less than a time length of the PRACH configuration period.

Aspect 13: The method of any of aspects 1 through 12, further comprising receiving a second random access configuration indicating a second association period, wherein the association period is associated with the one or more SBFD symbols, and the second association period is associated with the one or more non-SBFD symbols.

Aspect 14: The method of aspect 13, further comprising maintaining, at the UE, the mapping between the one or more reference signals and the plurality of random access occasions for the association period separately from a second mapping between the one or more reference signals and the plurality of random access occasions for the association period for the second association period.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, an indication of a random access configuration for subband full duplex (SBFD) operations, the random access configuration indicating an association period for operation in accordance with both of one or more SBFD symbols and one or more non-SBFD symbols, and the random access configuration corresponding to a mapping between one or more reference signals and a plurality of random access occasions within the association period;
receive the one or more reference signals from the network entity; and
transmit, based at least in part on the one or more reference signals, a random access message via a random access occasion of the plurality of random access occasions in accordance with the mapping between the one or more reference signals and the plurality of random access occasions within the association period.

2. The UE of claim 1, wherein the random access configuration is a first random access configuration, and the one or more processors are individually or collectively operable to execute the code to cause the UE to:
receive a second random access configuration indicating a second association period, wherein the association period is associated with the one or more SBFD symbols, and the second association period is associated with the one or more non-SBFD symbols.

3. The UE of claim 2, wherein the one or more processors are individually or collectively operable to execute the code to cause the UE to:
maintain, at the UE, the mapping between the one or more reference signals and the plurality of random access occasions for the association period separately from a second mapping between the one or more reference signals and the plurality of random access occasions for the association period for the second association period.

4. The UE of claim 1, wherein, to transmit the random access message, the one or more processors are individually or collectively operable to execute the code to cause the UE to:
transmit, during the random access occasion, the random access message via a physical random access channel resource associated with a synchronization signal block index, wherein the random access occasion is selected based at least in part on the association period and on one or more measurements of the one or more reference signals, wherein an association pattern period for the operation in accordance with both of the one or more SBFD symbols and the one or more non-SBFD symbols is different than a second association pattern period for operation in accordance with the one or more non-SBFD symbols.

5. The UE of claim 1, wherein, to transmit the random access message, the one or more processors are individually or collectively operable to execute the code to cause the UE to:
transmit, during the random access occasion, the random access message via a physical random access channel resource associated with a synchronization signal block index, wherein the random access occasion is selected based at least in part on the association period and on one or more measurements of the one or more reference signals, wherein a time length of the association period is the same as a time length of a second association period for operation in accordance with the one or more non-SBFD symbols.

6. The UE of claim 5, wherein an integer number of mappings between the one or more reference signals and the plurality of random access occasions within the association period are different for the operation in accordance with both of the one or more SBFD symbols and the one or more non-SBFD symbols than operation in accordance with the one or more non-SBFD symbols.

7. The UE of claim 1, wherein, to transmit the random access message, the one or more processors are individually or collectively operable to execute the code to cause the UE to:
transmit, during the random access occasion, the random access message via a physical random access channel resource associated with a synchronization signal block index, wherein the random access occasion is selected based at least in part on the association period and on one or more measurements of the one or more reference signals, wherein the association period is determined by the UE and is based at least in part on a minimum integer number of mappings between the one or more reference signals and the plurality of random access occasions.

8. The UE of claim 1, wherein, to transmit the random access message, the one or more processors are individually or collectively operable to execute the code to cause the UE to:
transmit, during the random access occasion, the random access message via a physical random access channel resource associated with a synchronization signal block index, wherein the random access occasion is selected based at least in part on the association period and on one or more measurements of the one or more reference signals, wherein the one or more reference signals are mapped to a same set of random access occasions associated with both the one or more SBFD symbols and the one or more non-SBFD symbols as one or more reference signals associated with the one or more non-SBFD symbols, wherein the plurality of random access occasions comprises the same set of random access occasions.

9. The UE of claim 8, wherein a time length of the association period is a same time length as a second association period for operation in accordance with the one or more non-SBFD symbols.

10. The UE of claim 8, wherein the association period is determined by the UE and is based on a minimum integer number of mappings between the one or more reference signals and the plurality of random access occasions.

11. The UE of claim 8, wherein the association period is determined by the UE and is based on a minimum integer number of mappings between the one or more reference signals and the plurality of random access occasions ensuring that each of the mappings include a maximum number of random access preambles for transmission.

12. The UE of claim 1, wherein:
an association pattern period is determined by the UE and comprises one or more association periods within a physical random access channel (PRACH) configuration period, and
the one or more association periods are exclusively for UEs operating in accordance with both of the one or more SBFD symbols and the one or more non-SBFD symbols.

13. The UE of claim 12, wherein:
the one or more association periods are determined by the UE and are based at least in part on a second association pattern period for operation in accordance with the one or more non-SBFD symbols, and
a time length of the one or more association periods is different than a total time length of the second association pattern period.

14. The UE of claim 12, wherein:
the one or more association periods are determined by the UE and are based at least in part on a time length of the PRACH configuration period, and
a time length of the one or more association periods is less than a time length of the PRACH configuration period.

15. A method for wireless communications at a user equipment (UE), comprising:
receiving, from a network entity, an indication of a random access configuration for subband full duplex (SBFD) operations, the random access configuration indicating an association period for operation in accordance with both of one or more SBFD symbols and one or more non-SBFD symbols, and the random access configuration corresponding to a mapping between one or more reference signals and a plurality of random access occasions within the association period;
receiving the one or more reference signals from the network entity; and
transmitting, based at least in part on the one or more reference signals, a random access message via a random access occasion of the plurality of random access occasions in accordance with the mapping between the one or more reference signals and the plurality of random access occasions within the association period.

16. The method of claim 15, further comprising:
receiving a second random access configuration indicating a second association period, wherein the association period is associated with the one or more SBFD symbols, and the second association period is associated with the one or more non-SBFD symbols.

17. The method of claim 16, further comprising:
maintaining, at the UE, the mapping between the one or more reference signals and the plurality of random access occasions for the association period separately from a second mapping between the one or more reference signals and the plurality of random access occasions for the association period for the second association period.

18. The method of claim 15, wherein transmitting the random access message comprises:
transmitting, during the random access occasion, the random access message via a physical random access channel resource associated with a synchronization signal block index, wherein the random access occasion is selected based at least in part on the association period and on one or more measurements of the one or more reference signals, wherein an association pattern period for the operation in accordance with both of the one or more SBFD symbols and the one or more non-SBFD symbols is different than a second association pattern period for operation in accordance with the one or more non-SBFD symbols.

19. The method of claim 15, wherein transmitting the random access message comprises:
transmitting, during the random access occasion, the random access message via a physical random access channel resource associated with a synchronization signal block index, wherein the random access occasion is selected based at least in part on the association period and on one or more measurements of the one or more reference signals, wherein a time length of the association period is the same as a time length of a second association period for operation in accordance with the one or more non-SBFD symbols.

20. The method of claim 19, wherein an integer number of mappings between the one or more reference signals and the plurality of random access occasions within the association period are different for the operation in accordance with both of the one or more SBFD symbols and the one or more non-SBFD symbols than operation in accordance with the one or more non-SBFD symbols.
